(19) United States
(12) Patent Application Publication
(10) Pub. No.: US 2001/0050106 A1
(43) Pub. Date: Dec. 13, 2001

(54) Nonreturn valve

(76) Inventors: Ahmet Turker, Lubeck (DE); Olaf Wohlenberg, Heidekamp (DE); Matthias Witt, Lubeck (DE)

Correspondence Address: MCGLEW & TUTTLE, PC, SCARBOROUGH STATION, SCARBOROUGH, NY, 10510, US

(21) Appl. No.: 09/793,829

(22) Filed: Feb. 26, 2001

(30) Foreign Application Priority Data
Jun. 8, 2000 (DE) 100 28 334.9-44

(51) Int. Cl. F16K 15/02

(52) U.S. Cl. 137/533.19

(57) ABSTRACT

A nonretum valve with a valve disk (2) located on a valve seat (3) and with guide supports on the circumference of the valve disk is improved such that the wear on the guide supports is reduced to a minimum. This is accomplished with guide supports designed as pins (7) mounted in a rotatably movable manner.

### FIELD OF THE INVENTION

The present invention pertains to a nonretum valve with a valve disk located on a valve seat and with guide supports on the circumference of said valve disk.

### BACKGROUND OF THE INVENTION

A nonrwetum valve of this type in the form of an expiration valve has been known from DE-PS 765 554. A valve disk, which is centered in relation to the valve seat (crater type structure) by means of individual guide supports, which are fastened to a component receiving the valve seat, lies on a valve seat. The valve disk is continually moving to and fro during the breathing movements and touches the guide supports in the process. If the valve disk consists of a solid material, e.g., ceramic, the guide supports will be worn off over time and marks may be formed, which compromise the free movement of the valve disk. Even though the friction between the valve disk and the guide supports can be reduced by means of a plastic ring extending at the edge of the valve disk, such a valve disk is difficult to manufacture and there is, moreover, the risk that the plastic ring becomes detached from the valve disk and then compromises the function of the nonreturn valve.

Ceramic disks are frequently used as valve disks in nonreturn valves ofrespirators. The centering of the ceramic disk in relation to the valve seat is brought about by guide pins located on the circumference of the valve disk. However, in the prior-art nonreturn valve, the pins are rigidly connected to the component receiving the valve seat, e.g., in the form of a bonded or soldered connection.

### SUMMARY AND OBJECTS OF THE INVENTION

The basic object of the present invention is to improve a nonretum valve of the above15 mentioned type such that the wear on the guide supports is reduced to a minimum.

According to the invention, a nonreturn valve is provided with a valve disk located on a valve seat (e.g., a crater like structure) and with guide supports on the circumference of the valve disk. The guide supports are designed as pins mounted in a rotatably movable manner.

The advantage of the present invention is essentially that due to the guide supports being arranged in a rotatably movable manner, a type of rolling movement takes place between the valve disk and the pins, by which the closing movement of the valve disk is supported, on the one hand, and the wear on the surface of the pins is markedly reduced, on the other hand. Due to the rotatably movable mounting of the pins, the pins can yield laterally on contact with the valve disk, as a result of which the contact zone between the valve disk and the pins is distributed over a larger pin surface.

The pins are advantageously mounted in a valve cage enclosing the valve disk, the valve cage being provided for this purpose with blind holes which are arranged on the circumference of a circle and into which the pins are inserted. The valve cage is then pulled together with the pins and the valve disk over the component receiving the valve seat. The arrangement of the blind holes in the valve cage has the advantage that the valve cage can be manufactured in a simple manner as a plastic molding and the blind holes can also be prepared by injection molding in one operation. As an alternative, the blind holes may also be arranged in the component that receives the valve seat.

Another alternative for fastening the pins is to arrange inwardly pointing projections, which enclose the pins in a clamp-like manner, on the side parts of the valve cage.

The suitable pins are conical or cylindrical pins which likewise consist of ceramic in the case of a valve disk consisting of ceramic.

The valve according to the present invention may be used particularly advantageously in the breathing gas flow of an anesthesia apparatus or respirator.

One exemplary embodiment of the present invention is shown in the figures and will be explained in greater detail below.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is the longitudinal section of a nonreturn valve;

FIG. 2 is a partial view of the nonreturn valve according to FIG. 1 with an alternative fastening for the pins;

FIG. 3 is a partial view of the valve cage with another alternative fastening for the pins; and

FIG. 4 is a perspective top view of a valve cage.

### DESCRIPTION OF THE PREFERRED EMBODIMENTS

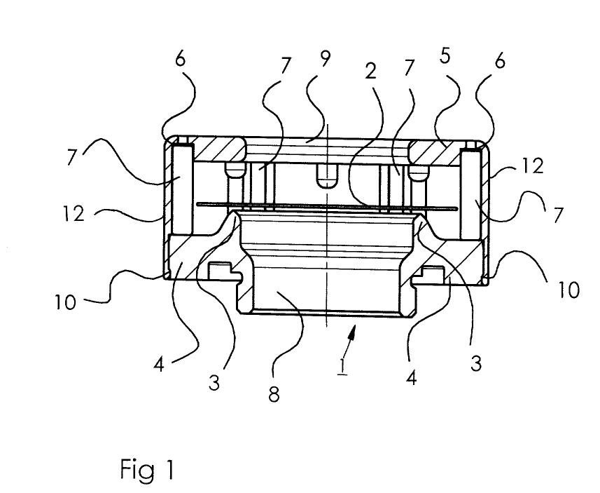

Referring to the drawings in particular, FIG. 1 schematically shows the design of a nonretum valve 1 according to the present invention. A valve disk 2, a valve seat 3 and a component 4 receiving the valve seat 3 are enclosed by a valve cage 5. The blind holes 6 are distributed over the circumference of the valve disk 2. Into the blind holes 6 pins 7, made of ceramic, are inserted in a rotatably movable manner, located on the top side of the valve cage 5. On the underside, the pins 7 are in contact with the component 4. A total of six pins 7 are arranged around the valve disk 2, and the valve disk 2 is centered in relation to the valve seat 3 by means of the pins 7. Only four of the pins 7 can be recognized in FIG. 1 because of the sectional view.

The direction of flow through the nonreturn valve 1 is from a gas inlet 8 to a gas outlet 9. The valve cage 5 and the component 4 are held together by a snap connection 10. During operation, the valve disk 2 is moved by the breathing gas flow up and down and the outer edge of the valve disk 2 now touches the pins 7. Due to the rotatably movable mounting of the pins 7 in the blind holes 6, the pins 7 can yield laterally, so that damage to the surface of the pins 7 due to the valve disk 2 sliding down is reduced to a minimum. The pins 7 are shielded by side walls 12 of the valve cage 5 against the outside.

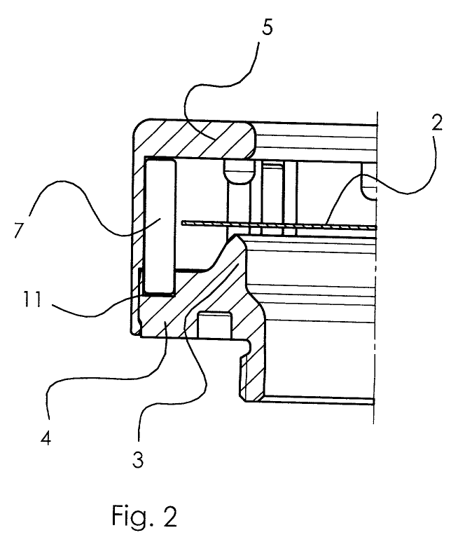

FIG. 2 shows an alternative embodiment of a nonreturn valve, in which blind holes 11 for the pins 7 are arranged in the component 4. Identical components are designated by the same reference numbers as in FIG. 1.

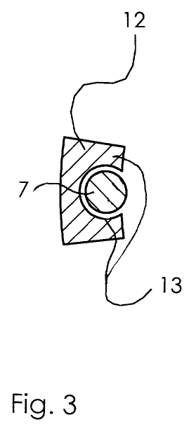

FIG. 3 illustrates another alternative embodiment for the fastening of the pins 7, in which clamp-like projections 13, into which the pins 7 can be pushed, are arranged at the side walls 12 of the valve cage 5. The internal diameter of the projections 13 is selected to be such that the rotary movement of the pins 7 is not hindered.

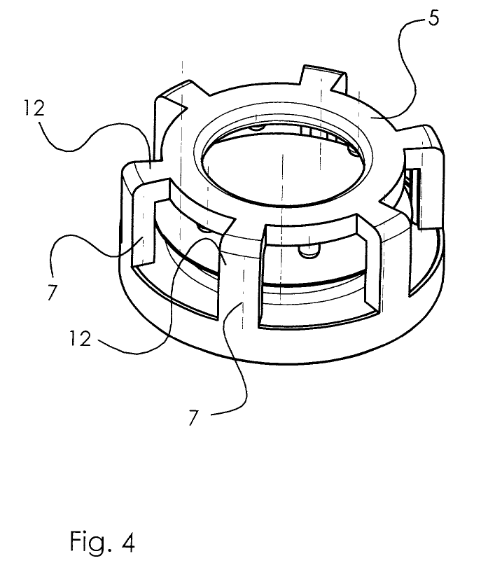

FIG. 4 shows a perspective top view of the valve cage 5 on a reduced scale. The pins 7 are schematically illustrated by a broken line.

While specific embodiments of the invention have been shown and described in detail to illustrate the application of the principles of the invention, it will be understood that the invention may be embodied otherwise without departing from such principles.

What is claimed is:

1. A nonreturn valve, comprising:
a valve seat;
a valve disk located on the valve seat; and
guide supports on the circumference of said valve disk, said guide supports comprising pins mounted in a rotatably movable manner.

2. A nonreturn valve in accordance with claim 1, further comprising a valve cage enclosing said valve disk, said pins being received in said valve cage.

3. A nonreturn valve in accordance with claim 2, wherein said blind holes for receiving said pins are provided in said valve cage.

4. A nonretum valve in accordance with claim 1, further comprising a component receiving said valve seat, wherein said blind holes for receiving said pins are arranged in said component.

5. A nonreturn valve in accordance with claim 2, wherein side parts of said valve cage have projections for the rotatably movable mounting of said pins.

6. A nonreturn valve in accordance with claim 1, wherein said pins are one of conical and cylindrical.

7. A nonreturn valve in accordance with claim 1, wherein said pins comprise a ceramic material.

8. A method of use a nonreturn valve, the method comprising the steps of:
providing a valve seat;
providing a valve disk located on the valve seat;
using guide supports on the circumference of said valve disk, the guide supports comprising pins mounted in a rotatably movable manner to form the non return valve; and
using the non return valve in a breathing gas circuit of a respirator.
